(19) United States
(12) Patent Application Publication
(10) Pub. No.: US 2006/0151433 A1
(43) Pub. Date: Jul. 13, 2006

(54) Method for removing and recoating of diamond-like carbon films and its products thereof

(76) Inventors: Chi-Lung Chang, Taichung City (TW); Da-Yung Wang, Taichung City (TW); Shu-man Li, Tianwei Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/031,076

(22) Filed: Jan. 10, 2005

(51) Int. Cl. B44C 1/22; C23F 1/00

(52) U.S. Cl. 216/81

(57) ABSTRACT

The invention relates to a method for removing and recoating of diamond-like carbon films and its products thereof. The method is to immerse the units that are coated with diamond-like carbon films into the hydrogen chloride solution to come off the coating, which was located on the units' surface. In addition, the method can effectively improve the past fault of poor adhesion, resulting from excessive residual stress and damaged unit surface due to the conventional sandblasting film removing process.

### FIELD OF THE INVENTION

The invention relates to a method for removing and recoating of diamond-like carbon films and its products thereof. The method is to immerse the units that are coated with diamond-like carbon films into a hydrogen chloride solution to come off the coating. The method without damaging the surfaces of the units can effectively get off diamond-like carbon films. The novel method is of great value to relative industry and reduces the production cost.

### BACKGROUND OF THE INVENTION

To modify the properties of the surfaces of the units, we use functional coatings of techniques of surface treatments. The method is extensively applied to semiconductor industry, photoelectric industry, mold industry, machining industry, machine tool industry, sports and recreation industry, construction, kitchen and plumbing industry, etc.

Diamond is the hardest in the Nature, and it covers the surfaces of the units by ion plating techniques to form diamond films or diamond-like carbon films. Diamond-like carbon films have sp³ bonding and sp² one of carbon. Therefore, they contain many properties that include high hardness, low friction coefficient, low chemical activity, high heat conductivity, low electric conductivity, etc. Due to the combination of superior properties, the ion plating techniques of diamond-like carbon films have many uses.

The structures of diamond-like carbon films are non-crystalline and they have carbon films of sp³ bonding and sp² one. Diamond-like carbon films are divided into hydrogen-containing diamond-like carbon films (a-c:H) and hydrogen-free diamond-like carbon films (a-c). Hydrogen-containing diamond-like carbon films are usually synthesized by the dissociation of hydro-carbon gases. The methods include Plasma Enhanced Chemical Vapor Deposition (PECVD), Hot-Filament Chemical Vapor Deposition (Hot-Filament CVD), etc. Hydrogen-free diamond-like carbon films (a-c) are made by the methods that include Magnetron Sputtering, Electron Beam Evaporation, Pulsed Laser Ablation (PLA), Cathodic Arc Evaporation, etc.

At present, the diamond-like carbon films suffered from frequent localized spalling due to the inherent high residual stress, incomplete pre-treatment, and other operating defects. An effective method for removing and recoating diamond-like carbon films is urgently needed.

By using dry sandblasting or wet sandblasting methods, diamond-like carbon films on the surfaces of bad units have been removed by means of mechanical erosion. Sandblasting method can peel off diamond-like carbon films and damages the surfaces of the units simultaneously; it is not fit for the units that are high precision, low surface roughness and sharp angles. And this method tends to damage the business prestige.

This invention can effectively remove the surface treatment without damaging the units. So far similar inventions have not appeared yet.

### SUMMARY OF THE INVENTION

This invention is to immerse the units that are coated with diamond-like carbon films into a chemical solution over a span. It can completely remove diamond-like carbon films on the surfaces of the units.

The chemical solution is a hydrogen chloride solution. Moreover, we can use a catalyst to control the chemical reaction rate. The catalyst is a nitric acid. By the experiments the inventors find the fact that adding a nitric acid in the chemical solution can accelerate effectively the rate of diamond-like carbon film removing.

The benefits of this invention are as follows: (1) the time of film removing is short; the relative production cost is lower and many good applications on industries. (2) The precision of the dimensions of the original units is intact. (3) The units that have diamond-like carbon films removed will retain the fine luster after polishing the surfaces again and recoating diamond-like carbon films.

Compare this invention with sandblasting, we can see the apparent advantage. The units that have diamond-like carbon films removed will have a lower roughness and fine luster of the surface, shown in FIG. 3 and FIG. 4 respectively.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 depicts the procedure diagram concerning the removing steps according to a preferred embodiment of this invention.

FIG. 2 depicts the procedure diagram concerning the successive steps of removing and recoating according to a preferred embodiment of this invention.

FIG. 3 depicts the roughness of the surfaces of the units of this invention.

FIG. 4 depicts the luster of the surfaces of the units of this invention.

FIG. 5 depicts the beginning photo and end one of the surfaces of the units for removing diamond-like carbon films.

### DETAILED DESCRIPTION OF THE PREFERRED EMBODIMENT

For achieving the foregoing purposes and virtues, the invention relates to a method for removing and recoating of diamond-like carbon films and its products thereof are to immerse a unit into a chemical solution and remove diamond-like carbon films on the surfaces of the unit. And then the same unit that has diamond-like carbon films removed can be recoated after polishing. This invention uses a hydrogen chloride solution that is common and easily obtainable.

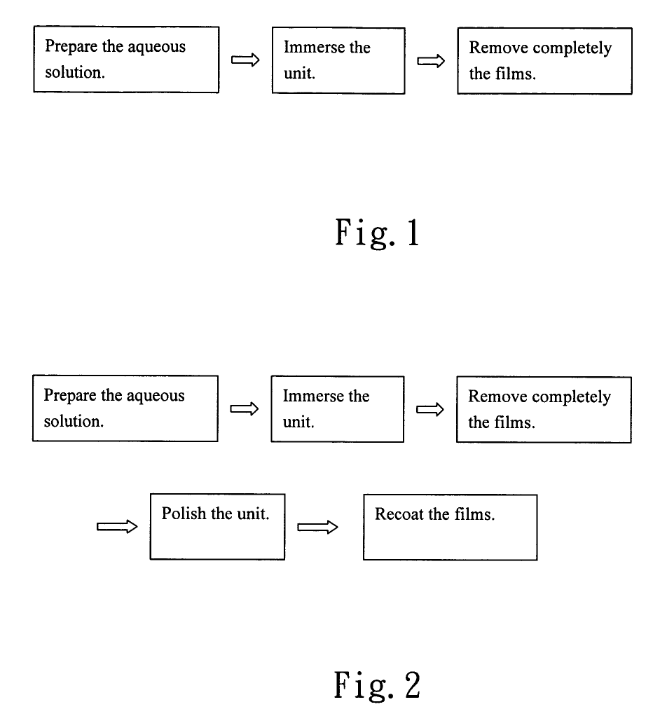

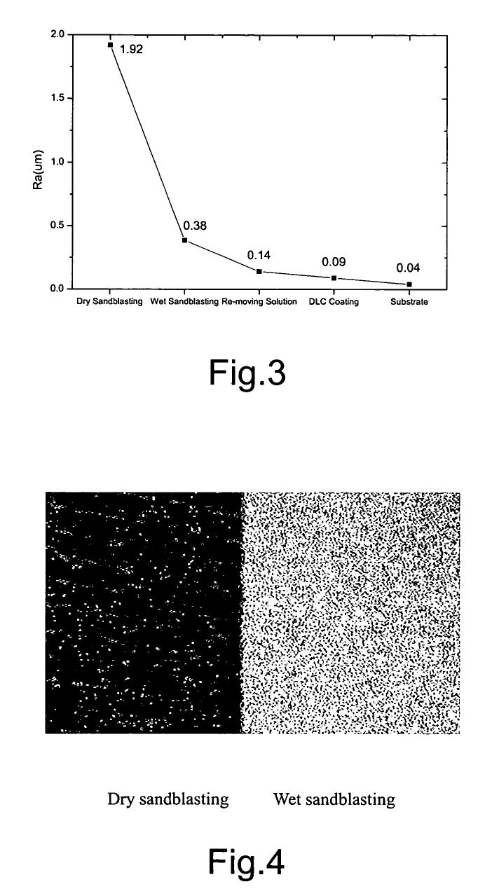

The removing steps are as follows, shown in FIG. 1.

a. Preparing a solution: a chemical solution is a hydrogen chloride solution whose concentration is ranged from 1% to 37%.

b. Immersing a unit: immersing a unit that is coated with diamond-like carbon films into the hydrogen chloride solution.

c. Film removing: in due time taking out the unit whose diamond-like carbon films have been completely removed according to the thickness of the films.

By using the method we can remove diamond-like carbon films without damaging the surfaces of the units.

The recoating steps are as follows, shown in FIG. 2.

a. Preparing a solution: a chemical solution is a hydrogen chloride solution whose concentration is ranged from 1% to 37%.

b. Immersing a unit: immersing a unit that is coated with diamond-like carbon films into the hydrogen chloride solution.

c. Film removing: in due time taking out the unit whose diamond-like carbon films have been completely removed according to the thickness of the films.

d. Polishing the unit: polishing the unit whose diamond-like carbon films have been removed.

e. Recoating films: recoating diamond-like carbon films onto the unit that has been polished as required.

The units whose diamond-like carbon films have been removed will become new products after polishing again and recoating the films. The surfaces of the new units whose diamond-like carbon films have been removed will have a lower roughness and a fine luster. The method can improve the quality of the new units.

The conditions of implementation and relative information and data of an example of this invention are as follows:

(1) The material of this unit: SUS304 stainless steel.

(2) The test area of the foregoing unit: 3 cm×2 cm.

(3) The film type: diamond-like carbon films.

(4) The film thickness: 2 μm.

(5) The aqueous solution: a hydrogen chloride solution whose concentration is 15%.

(6) The capacity of the aqueous solution: 500 ml.

(7) The temperature range of aqueous solution: 0° C.-100° C.

(8) The container: strong acids resistance.

The ways of implementation:

Immersing a unit that is coated with diamond-like carbon films into a hydrogen chloride solution whose capacity is 500 ml and concentration is from 1% to 37%.

The effect of implementation:

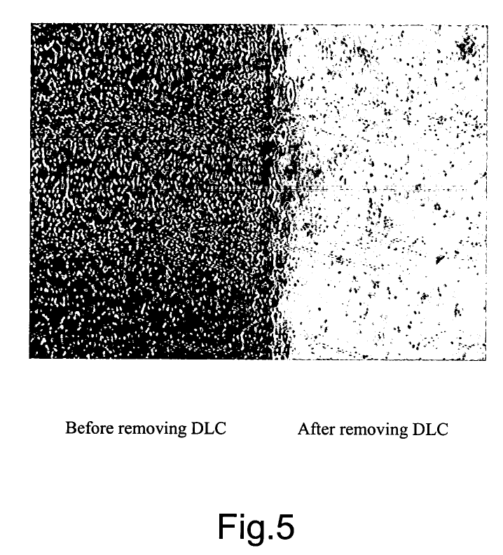

Through the immersing for a period of one minute to four hours, the surfaces of the unit have diamond-like carbon films has been removed completely, as shown in FIG. 5. The temperature of aqueous solution will affect the rate of film removing. At the same concentration, for example, 15%, the rate of film removing is 0.5 μm per hour at 25° C. and 0.5 μm per minute at 100° C. At room temperature (about 25° C. ) the best range of concentration is from 12% to 18%. Immersing a unit at this range of temperature and concentration until the film removing process is finished.

This invention has many benefits, for example, a hydrogen chloride solution is easy to acquire. For instance, if the concentration of aqueous solution has been adjusted to match the certain condition, the aqueous solution can be used at room temperature. Furthermore, the aqueous solution does not need to be heated or undergone other complicated procedures. This invention can avoid many problems associated with environmental safety.

Moreover, if the units have to have diamond-like carbon films removed, we do not need to worry about the fact that the original precision of the dimensions of the units will be affected. This invention is very convenient for units that have complex profiles. And it can reduce the expenses for preparing other manufacturing procedures such as grinding, milling, etc. This invention can remove directly diamond-like carbon films on the surfaces of the units. Because machining methods have not been used, the residual stress will not been produced in the units. The residual stress deforms the products and affects the precision and strength of the products and produces worse influence on the follow-up machining. The residual stress also makes light scatter from transparent optics products, and affects the optical properties of the products.

Besides, if we want to remove the coating, we can adjust the rate of film removing as required. The method is very economical and practical. Polish the units after diamond-like carbon films being removed, and then recoating new diamond-like carbon films. The surfaces of the new units will have a lower roughness and fine luster. The method can effectively improve the quality of the new units.

This invention is also added an adequate catalyst to control the reaction rate except the above-mentioned steps. The catalyst can use a nitric acid (HNO₃). By the inventors' experimental effect for tests, the fact is found that adding a nitric acid (HNO₃) to a chemical solution will effectively increase the rate of film removing. The relative information is as follows:

| Hydrogen | | | |
|---|---|---|---|
| chloride aqueous | Nitric acid | Time | The rate of film |
| solution (HCl)_{aq} | (HNO₃) | (minute) | removing (μm/hr) |
| 15% | None | 240 | 0.5 |
| 15% | Add 1 ml of 1% | 125 | 0.96 |
| 15% | Add 1 ml of 70% | 50 | 2.4 |

1. The range of concentration of nitric acid is from 1% to 70% to be effective.
2. For the above rate of film removing adding a nitric acid (HNO₃) whose concentration is from 1% to 70% will effectively improve the reaction rate.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded with the broadest interpretation so as to encompass all such modifications and similar structure.

What is claimed is:

1. A method for removing diamond-like carbon films, comprising the steps of:
a. Preparing a solution: the solution is a chemical solution;
b. Immersing a unit: immersing a unit that is coated with diamond-like carbon films into a chemical solution;
c. Film removing: taking out the unit after diamond-like carbon films have been completely removed.

2. The method for removing diamond-like carbon films according to claim 1, wherein the chemical solution is a hydrogen chloride solution.

3. The method for removing diamond-like carbon films according to claim 2, wherein the concentration of hydrogen chloride solution is from 1% to 37%.

4. The method for removing diamond-like carbon films according to claim 2, wherein the best range of concentration of hydrogen chloride solution is from 12% to 18%.

5. The method for removing diamond-like carbon films according to claim 1, wherein the temperature of chemical solution is room temperature.

6. The method for removing diamond-like carbon films according to claim 1, wherein the temperature range of chemical solution is from 0° C. to 100° C.

7. The method for removing diamond-like carbon films according to claim 1, wherein the rate of film removing is approximately 0.5 μm per hour at 25° C.

8. The method for removing diamond-like carbon films according to claim 1, wherein the rate of film removing is approximately 0.5 μm per minute at 100° C.

9. The method for removing diamond-like carbon films according to claim 1, wherein adding a catalyst in the chemical solution to control the reaction rate.

10. The method for removing diamond-like carbon films according to claim 9, wherein the catalyst is a nitric acid.

11. The method for removing diamond-like carbon films according to claim 9, wherein the catalyst is a nitric acid whose concentration is from 1% to 70%.

12. A method for recoating after removing diamond-like carbon films, comprising the steps of:
a. Preparing a solution: the solution is a chemical solution;
b. Immersing a unit: immersing a unit that is coated with diamond-like carbon films into a chemical solution;
c. Film removing: taking out the unit after diamond-like carbon films have been completely removed;
d. Polishing the unit: polishing the unit whose films have been removed;
e. Film recoating: recoating diamond-like carbon films to the unit that has been polished.

13. The method for recoating after removing diamond-like carbon films according to claim 12, wherein the chemical solution is a hydrogen chloride solution.

14. The method for recoating after removing diamond-like carbon films according to claim 13, wherein the concentration of hydrogen chloride solution is from 1% to 37%.

15. The method for recoating after removing diamond-like carbon films according to claim 13, wherein the best range of concentration of hydrogen chloride solution is from 12% to 18%.

16. The method for recoating after removing diamond-like carbon films according to claim 12, wherein the temperature of chemical solution is room temperature.

17. The method for recoating after removing diamond-like carbon films according to claim 12, wherein the temperature range of chemical solution is from 0° C. to 100° C.

18. The method for recoating after removing diamond-like carbon films according to claim 12, wherein the rate of film removing is approximately 0.5 μm per hour at 25° C.

19. The method for recoating after removing diamond-like carbon films according to claim 12, wherein the rate of film removing is approximately 0.5 μm per minute at 100° C.

20. The method for recoating after removing diamond-like carbon films according to claim 12, wherein adding a catalyst in the chemical solution to control the reaction rate.

21. The method for recoating after removing diamond-like carbon films according to claim 20, wherein the catalyst is a nitric acid.

22. The method for recoating after removing diamond-like carbon films according to claim 20, wherein the catalyst is a nitric acid whose concentration is from 1% to 70%.

23. A product coated with diamond-like carbon films; polish and recoating the product whose diamond-like carbon films have been removed.

24. The product coated with diamond-like carbon films according to claim 23, wherein the removed diamond-like carbon films come from a unit removing the films after immersing the unit into a hydrogen chloride solution.
